(19) United States
(12) Patent Application Publication
(10) Pub. No.: US 2023/0410636 A1
(43) Pub. Date: Dec. 21, 2023

(54) SYSTEM FOR MANAGING A NETWORK OF PERSONAL SAFETY ACCESSORIES

(71) Applicant: Wonder Jewel Ltd., Caesarea (IL)

(72) Inventor: Nitzan KISH, Binyamina (IL)

(73) Assignee: Wonder Jewel Ltd., Caesares (IL)

(21) Appl. No.: 18/035,291

(22) PCT Filed: Nov. 4, 2021
(86) PCT No.: PCT/IL2021/051314

§ 371 Date: May 4, 2023

Related U.S. Application Data
(60) Provisional application No. 63/110,071, filed on Nov. 5, 2020.

(51) Int. Cl. G08B 25/01

(52) U.S. Cl. CPC G08B 25/016; G08B 25/012

(57) ABSTRACT

A personal safety system is provided herein. The system may include: (i) at least two connectable personal accessories, each having at least one sensor to detect a specified event; and a processor to connect the accessory to at least one data network and communicate a detection over the network; (ii) a server; and (iii) at least two instances of an app on respective at least two devices communicatively connected to the at least two accessories. The processor of a first accessory is configured to communicate a detection to a first instance of the app on a first personal device and the first instance app is configured to forward the detection to the server. The server is configured to connect to at least one second instance of the app on a second personal device and communicate the detection to the at least one second instance app.

### FIELD AND BACKGROUND OF THE INVENTION

The present invention relates to a system for collecting and analyzing behavioral and physiological data, and more particularly, to a system for managing a network of jewelry and/or accessories and/or garment based wearable personal safety system for detecting and alerting user distress and/or other feelings.

### SUMMARY OF THE INVENTION

According to some embodiments of the present invention, a personal safety system is provided herein. The system may include: (i) at least one connectable personal accessory, each having at least one sensor or button to detect or indicate a event and/or indices or change in indices; and a processor to connect the accessory to at least one data network and communicate a detection over the network; (ii) a server; and (iii) at least one instance of an app on respective at least two devices communicatively connected to the at least two accessories. The processor of a first accessory is configured to communicate a detection to a first instance of the app on a first personal device and the first instance app is configured to forward the detection to the server. The server may be selectively configured, based on wearer choice to connect to at least one second instance of the app on a second personal device or other interface module and communicate the detection to the at least one second instance app.

### BRIEF DESCRIPTION OF THE DRAWINGS

Some embodiments of the invention are herein described, by way of example only, with reference to the accompanying drawings and images. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced. In the drawings:

FIG. 1A is a block diagram of a connectable personal accessory in accordance with an embodiment of the present invention;

FIG. 1B is an illustration of a user with two exemplary connectable personal accessories in accordance with an embodiment of the present invention;

FIG. 2 is a block diagram of a server and mobile communications device;

FIG. 3 is a block diagram of a Personal Safety System in accordance with an embodiment of the present invention:

FIG. 4 is a block diagram of a Personal Safety System in accordance with an embodiment of the present invention;

FIG. 5 is a block diagram of a Personal Safety System in accordance with an embodiment of the present invention;

FIG. 6 is a flow chart illustration of use of a Personal Safety System alert process in accordance with an embodiment of the present invention; and

FIG. 7 is a flow chart illustration of use of a Personal Safety System alert process in accordance with an embodiment of the present invention.

### DETAILED DESCRIPTION OF EMBODIMENTS OF THE INVENTION

The present invention, in some embodiments thereof, relates to a system for collecting and analyzing behavioral and physiological data, and more particularly, but not exclusively, to a jewelry, accessory/accessories, and/or garment based wearable personal safety system for detecting and alerting user distress. The wearable personal safety system may also allow for emergency communication, preventive measures and/or lifestyle considerations (e.g., fitness, health stress monitoring) etc.

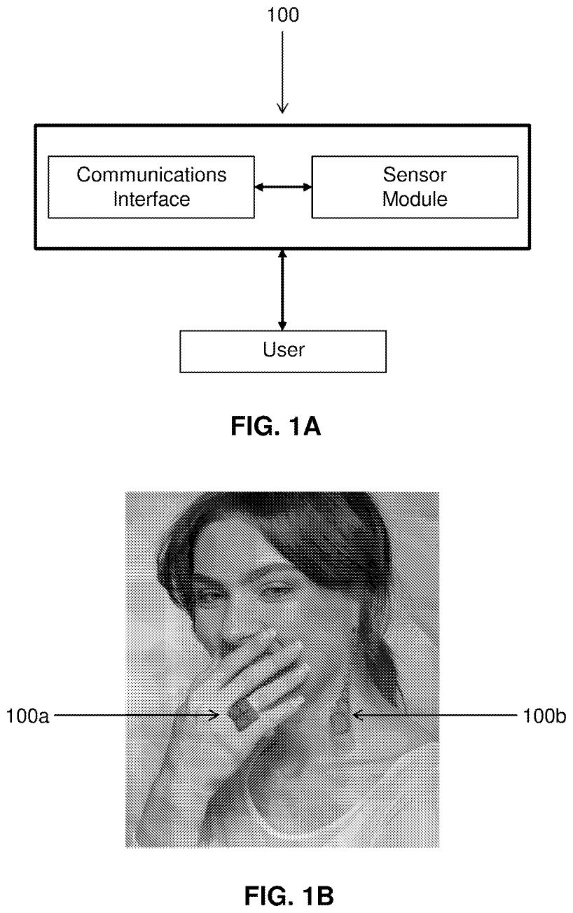

FIG. 1A is a block diagram of a connectable personal accessory 100 in accordance with embodiments of the present invention. One or more connectable personal accessories may be components in a personal safety system as will be described herein.

In some embodiments of the present invention, the connectable personal accessory may comprise active components, for example at least one sensor of a Sensor Module and/or a communications interface.

At least one sensor may be configured to detect a specified event (e.g. a distress situation). The communications interface may comprise at least one processor configured to communicatively connect the connectable personal accessory to at least one data network and communicate a detection of a specified event over the at least one data network.

The at least one data network may be a wired or wireless data network. The connectable personal accessory may use more than one data network as required. For example, a processor of the communications interface may communicate a detection of a specified event to an app executed on a smartphone associated with a user of the connectable personal accessory over a first data network (e.g., Bluetooth): the app may then communicate the detection to a server over a second data network (e.g., internet/Wi-Fi).

FIG. 1B is an illustration of a user with two connectable personal accessories 100a and 100b in accordance with an embodiment of the present invention.

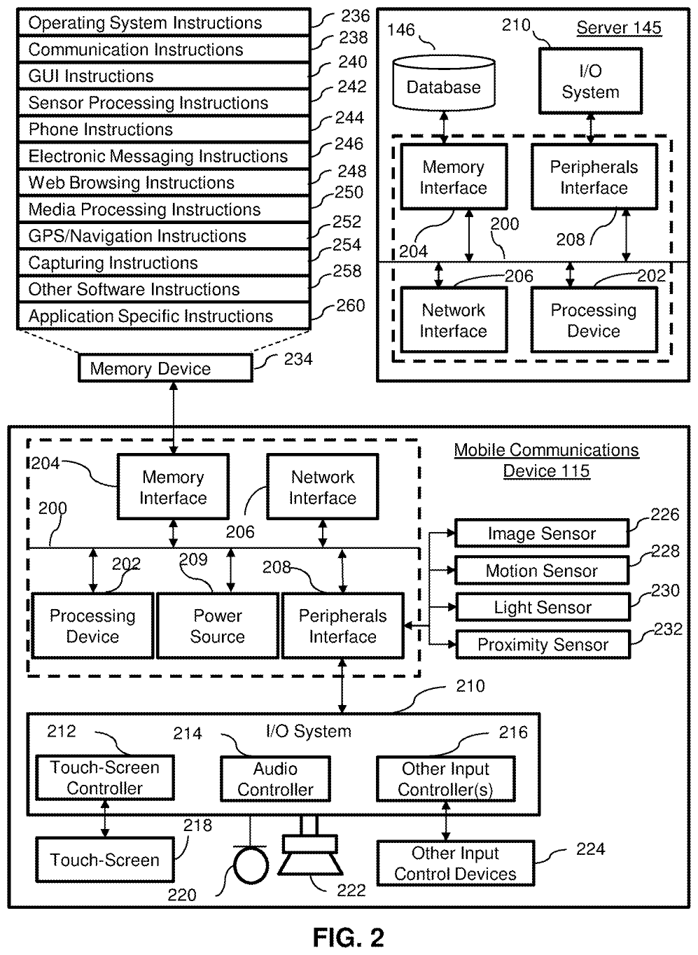

FIG. 2 is an exemplary block diagram of configurations of a server 145 and a mobile communications device 115. A mobile communications device 115 may otherwise be referred to as a personal device, and may be, for example, a smartphone. Elements of FIG. 2 may be incorporated into any other embodiment as described herein or represented in any other figure. In one embodiment, server 145 and mobile communications device 115 directly or indirectly accesses a bus 200 (or other communication mechanism) that interconnects subsystems and components for transferring information within server 145 and/or mobile communications device 115. For example, bus 200 may interconnect a processing device 202, a memory interface 204, a network interface 206, a peripherals interface 208 connected to I/O system 210, and power source 209.

Processing device 202, shown in FIG. 2, may include at least one processor configured to execute computer programs, applications, methods, processes, or other software to perform embodiments described in the present disclosure. For example, the processing device may include one or more integrated circuits, microchips, microcontrollers, microprocessors, all or part of a central processing unit (CPU), graphics processing unit (GPU), digital signal processor (DSP), field programmable gate array (FPGA), or other circuits suitable for executing instructions or performing logic operations. The processing device may include at least one processor configured to perform functions of the disclosed methods such as a microprocessor manufactured by Intel™. The processing device may include a single core or multiple core processors executing parallel processes simultaneously. In one example, the processing device may be a single core processor configured with virtual processing technologies. The processing device may implement virtual machine technologies or other technologies to provide the ability to execute, control, run, manipulate, store, etc., multiple software processes, applications, programs, etc. In another example, the processing device may include a multiple-core processor arrangement (e.g., dual, quad core, etc.) configured to provide parallel processing functionalities to allow a device associated with the processing device to execute multiple processes simultaneously. It is appreciated that other types of processor arrangements could be implemented to provide the capabilities disclosed herein.

In some embodiments, processing device 202 may use memory interface 204 to access data and a software product stored on a memory device or a non-transitory computer-readable medium. For example, server 145 may use memory interface 204 to access data structure 146 (e.g. a database). As used herein, a non-transitory computer-readable storage medium refers to any type of physical memory on which information or data readable by at least one processor can be stored. Examples include random access memory (RAM), read-only memory (ROM), volatile memory, nonvolatile memory, hard drives, CD ROMs, DVDs, flash drives, disks, any other optical data storage medium, any physical medium with patterns of holes, a RAM, a PROM, and EPROM, a FLASH-EPROM or any other flash memory. NVRAM, a cache, a register, any other memory chip or cartridge, and networked versions of the same. The terms “memory” and “computer-readable storage medium” may refer to multiple structures, such as a plurality of memories or computer-readable storage mediums located within mobile communications device 115, server 145, or at a remote location. Additionally, one or more computer-readable storage mediums can be utilized in implementing a computer-implemented method. The term “computer-readable storage medium” should be understood to include tangible items and exclude carrier waves and transient signals.

Both mobile communications device 115 and server 145 may include network interface 206 coupled to bus 200. Network interface 206 may provide two-way data communications to a network. In FIG. 2, the wireless communication between mobile communications device 115 and server 145 is represented by a dashed arrow. In one embodiment, network interface 206 may include an integrated services digital network (ISDN) card, cellular modem, satellite modem, or a modem to provide a data communication connection over the Internet. As another example, network interface 206 may include a wireless local area network (WLAN) card. In another embodiment, network interface 206 may include an Ethernet port connected to radio frequency receivers and transmitters and/or optical (e.g., infrared) receivers and transmitters. The specific design and implementation of network interface 206 may depend on the communications network(s) over which mobile communications device 115 and server 145 are intended to operate. For example, in some embodiments, mobile communications device 115 may include network interface 206 designed to operate over a 5G, LTE, 3G, GSM network, a GPRS network, an EDGE network, a Wi-Fi or WiMAX network, and a Bluetooth® network. In any such implementation, network interface 206 may be configured to send and receive electrical, electromagnetic, or optical signals that carry digital data streams representing various types of information.

Both mobile communications device 115 and server 145 may also include peripherals interface 208 coupled to bus 200. Peripherals interface 208 may be connected to sensors, devices, and subsystems to facilitate multiple functionalities. In one embodiment, peripherals interface 208 may be connected to I/O system 210 configured to receive signals or input from devices and to provide signals or output to one or more devices that allow data to be received and/or transmitted by mobile communications device 115 and server 145. In one example I/O system 210 may include a touch screen controller 212, audio controller 214, and/or other input controller(s) 216. Touch screen controller 212 may be coupled to a touch screen 218. Touch screen 218 and touch screen controller 212 may, for example, detect contact, movement or break thereof using any of a plurality of touch sensitivity technologies, including but not limited to capacitive, resistive, infrared, and surface acoustic wave technologies as well as other proximity sensor arrays or other elements for determining one or more points of contact with the touch screen 218. Touch screen 218 may also, for example, be used to implement virtual or soft buttons and/or a keyboard for communicating. While a touch screen 218 is shown in FIG. 2, I/O system 210 may include a display screen (e.g., CRT or LCD) in place of touch screen 218. Audio controller 214 may be coupled to a microphone 220 and a speaker 222 to facilitate voice-enabled functions, such as voice recognition, voice replication, digital recording, and telephony functions. The other input controller(s) 216 may be coupled to other input/control devices 224, such as one or more buttons, rocker switches, thumbwheel, infrared port. USB port, and/or a pointer device such as a stylus.

With regard to mobile communications device 115, peripherals interface 208 may also be connected to an image sensor 226, a motion sensor 228, a light sensor 230, and/or a proximity sensor 232 to facilitate image capturing, orientation, lighting, and proximity functions. Other sensors (not shown) may also be connected to the peripherals interface 208, such as a temperature sensor, a biometric sensor, or other sensing devices to facilitate related functionalities. In addition, a GPS receiver may also be integrated with, or connected to, mobile communications device 115, such as GPS receivers typically integrated into mobile communications devices. Alternatively. GPS software may permit a mobile communications device to access AN external GPS receiver (e.g., connecting via a serial port or Bluetooth).

Consistent with the present disclosure, mobile communications device 115 may use memory interface 204 to access memory device 234. Memory device 234 may include high-speed random-access memory and/or non-volatile memory such as one or more magnetic disk storage devices, one or more optical storage devices, and/or flash memory (e.g., NAND, NOR). Memory device 234 may store an operating system 236, such as DARWIN, RTXC, LINUX, iOS, UNIX, OSX, WINDOWS, or an embedded operating system such as VxWorks. The operating system 236 may include instructions for handling basic system services and for performing hardware-dependent tasks. In some implementations, the operating system 236 may be a kernel (e.g., UNIX kernel).

Memory device 234 may also store communication instructions 238 to facilitate communicating with one or more additional devices, one or more computers and/or one or more servers. Memory device 234 may include: graphical user interface instructions 240 to facilitate graphic user interface processing; sensor processing instructions 242 to facilitate sensor-related processing and functions; phone instructions 244 to facilitate phone-related processes and functions; electronic messaging instructions 246 to facilitate electronic-messaging related processes and functions; web browsing instructions 248 to facilitate web browsing-related processes and functions; media processing instructions 250 to facilitate media processing-related processes and functions; GPS/navigation instructions 252 to facilitate GPS and navigation-related processes and instructions; capturing instructions 254 to facilitate processes and functions related to image sensor 226; and/or other software instructions 258 to facilitate other processes and functions.

Each of the above identified instructions and applications may correspond to a set of instructions for performing one or more functions described above. These instructions need not be implemented as separate software programs, procedures, or modules. Memory device 234 may include additional instructions or fewer instructions. Furthermore, various functions of mobile communications device 115 may be implemented in hardware and/or in software, including in one or more signal processing and/or application specific integrated circuits. For example, mobile communications device 115 may execute an image processing algorithm to identify objects in a received image. In addition, the components and arrangements shown in FIG. 2 are not intended to limit the disclosed embodiments. As will be appreciated by a person skilled in the art having the benefit of this disclosure, numerous variations and/or modifications may be made to the depicted configuration of server 145. For example, not all components may be essential for the operation of server 145 in all cases. Any component may be located in any appropriate part of server 145, and the components may be rearranged into a variety of configurations while providing the functionality of the disclosed embodiments. For example, some servers may not include all the elements in I/O system 210.

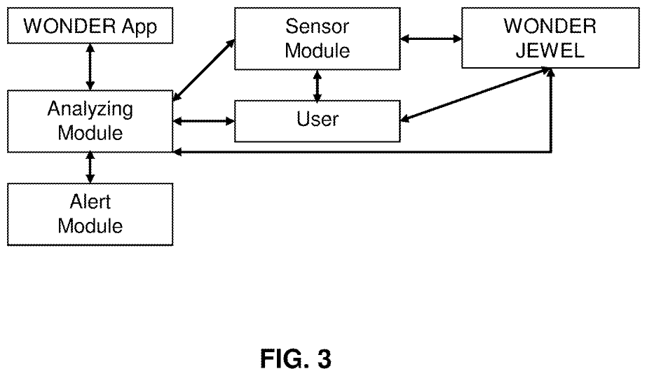

With reference now to FIG. 3, an aspect of some embodiments of the present invention relates to a system, referred to herein as the Personal Safety System (PSS), that may be unattended (e.g., capable of operating without direct human intervention) and may comprise a wearable component (such as connectable personal accessory 100). The PSS may combine the functions of monitoring parameters of a user, analyzing the parameters in real time (e.g., event to system response on the order of milliseconds or microseconds) in order to calculate a user distress situation, and automatically and/or manually alert people and/or authorities (e.g., police, ambulance/paramedics/first aid responders, fire & rescue). The PSS may monitor and analyze other factors of the distress situation and/or other emotions.

The PSS may comprise a wearable component, referred to herein as a connectable personal accessory (as shown in FIGS. 1A and 1B). Wearable Safety Monitor. or Wonder Jewel (WJ). The connectable personal accessory may optionally have the form factor of at least one of jewelry, clothing, and/or accessories. For example, the connectable personal accessory may be, but is not limited to: a necklace, a pendant, a locket, a brooch, an earring, a ring, a bracelet, a watch, a garment, an item of clothing, a phone charm, a keyring/keyfob, etc. Optionally, the connectable personal accessory may have a personalized form factor and/or design so that users may adapt the design according to personal preferences. The connectable personal accessory may not be limited to safety monitoring, but may also be used to communicate other information, to warn of possible developing situations and/or for other lifestyle purposes such as social networking, payments, entertainment, nurturing trust, wellness, communication, preventive measures and/or monitoring a person's feelings.

The connectable personal accessory may comprise at least one sensor, and when worn by the user, the sensor(s) may generate data for monitoring the user. The connectable personal accessory may comprise a communications interface such as a processor for transmitting the data over a data network to a platform which may employ algorithms to calculate that the user is in a distress situation. Optionally, the connectable personal accessory may perform the calculations. Optionally, the connectable personal accessory may communicate with other communicating devices, for example a smartphone (as shown, for example, in FIG. 2), which may act as a calculating platform and/or an interface to a cloud network and/or another connectable personal accessory.

Optionally, the calculations may comprise algorithms, for example supervised machine learning algorithms.

Optionally, the calculations may include data from sources other than the PSS, for example historical databases of data, data acquired from a PSS attached to different users, and/or other sources.

Optionally, the calculations may comprise calculating whether the user wearing the PSS is in a distress situation. Optionally, the analysis may further comprise alerting pre-defined persons and/or authorities/institutions about the user distress situation.

Optionally, the algorithms and/or calculations may be personalized for a specific user, by the user or by a legal guardian

Optionally, the PSS may provide real time alerting of a user experiencing a distress situation, for example domestic violence, sexual harassment, forced sex, verbal abuse, panic attack, mugging, robbery, rioting, and/or any other type of distress. In this way, the PSS may significantly reduce the time delay between the onset of a distress situation and the arrival of assistance.

Optionally, the PSS may provide feedback to a user experiencing a more mild form of distress situation, for example elevated stress levels, and may be used as a personal well-being device to provide bio-feedback and other forms of feedback to assist an individual in achieving a sense of lifestyle or well-being.

Optionally, the PSS may further comprise a community of amateur and/or trained individuals who may be randomly located in geographic proximity to a user in a distress situation, thereby increasing the likelihood of a timely response.

In some embodiments, the present invention may be method for automatically monitoring, diagnosing, and alerting that a user is in a distress situation using a PSS that is attached to the user.

Optionally the PSS may comprise integration of several modules, for example a Sensor Module comprising a plurality of sensors that generate data from monitoring a user's biometric, behavioral and/or physiological parameters, an Analyzing Module for analyzing data received from the Sensor Module and calculating at least one distress scenario, a User Interface Module for inputting instructions and viewing messages from the Analyzing Module, and an Alerting Module for outputting alerts to persons, authorities, communications devices, and/or computerized devices.

Optionally, the PSS may comprise an application/app that executes on a processor of a smartphone (such as mobile communications device 115), referred to herein as the Safety App (SA).

Optionally, the SA may comprise capabilities for providing selected permissions of interaction between users, thereby enabling PSS user communities. An instance of the app associated with a particular user for the purposes of considering example scenarios may be referred to as a first instance app. Other users within the community may be referred to as second users and may be associated with second instance apps. For example, at least one of the following may be taken into consideration by the app when determining selected permissions:
(a) a profile of a user of at least one second instance app or the first instance app;
(b) a preference of at least one of: a user of the first instance app; or a user of the at least one second instance app;
(c) a location of a user of the at least one second instance app;
(d) an availability of a user of the at least one second instance app;
(e) a security credential of a user of the at least one second instance app; and
(f) a relationship between a user of the first instance app and a user of the at least one second instance app (e.g., friend, family, contact).
(g) preferences for the second user based on age, capabilities, gender and the like.

Optionally, the above-mentioned modules may be connected to each other with wired, wireless, cellular and/or any other type of electronic and/or optical data connections.

Optionally the above mentioned modules may comprise a single device, and/or a distributed system with modules communicating over a data network. Optionally each module may be implemented on one or more devices in the distributed system.

In future commercial applications, the connectable personal accessory may be referred to as a Wonder Jewel, the Safety Application may be referred to as the Wonder App, and a user community may be referred to as the Wonder Community. The users of the app may be referred to as “Wondera”. Specific users who already rescued other users may be “Wonder Hero” and specific users may be referred to “Wonder Ambassadors”.

The connectable personal accessory may monitor and/or communicate in real time, for example: real-time operation and measurement; activation, transfer, and data retention with another device (such as a smartphone) in real time (e.g. location/pictures/sound, etc.); an alert and/or signal can be transmitted in real time to the community, authorities, contacts, private security etc.; preservation of information and knowledge to future data analysis and/or operation.

A community of users may be formed. If a community is established, it may be composed of connectable personal accessory users and other people from the wider community, who have undergone security processes and are interested in helping others when needed. Authorities may also be able to receive information/data shared with the community, possibly subject to permission and or notice of the users. The connectable personal accessory will optionally be fashionable and stylish. There may be various collections/ranges and materials available. Alternatively or additionally, the elements of the system may be embodied in other styles, other wearable or carriable items and accessories.

In some embodiments, the connectable personal accessory will integrate into everyday life and/or be comfortable to wear and/or camouflaged/appeared as fashion jewelry and/or reduce the barriers that self-protection and self-defense items often have.

In some embodiments, the connectable personal accessory will include internet of things (IoT) technologies.

In some embodiments, the connectable personal accessory may: help reduce violence and help stop violent attacks in real time (perhaps even before they occur); detect emergency cases, distress and/or other emotions by active manual input/action of the user and/or automatically without the need for the user's activation; assist in communicating emergency cases to enable real-time aid; identify in advance violent behavior and/or other behavior patterns among the victims and report it; and be able to interface with other communities, apps, and platforms.

In some embodiments, the Wonder Jewels may help detect potential risk from the users to the environment in addition to detecting risks to the users from the environment.

The present invention, in some embodiments thereof, relates to a system for collecting and analyzing behavioral and physiological data, and more particularly but not exclusively, to a jewelry based wearable personal safety system for detecting and alerting user distress.

In some embodiments, one or more sensors of the Sensor Module, as described below, may be integrated with the connectable personal accessory. Optionally the connectable personal accessory and/or the Sensor Module may comprise a button, either mechanical, electronic, and/or touch screen, that may generate an alert and/or cancel an alert, for example by the Analyzing Module as described below.

Optionally the connectable personal accessory and/or the Sensor Module may comprise a form of illumination, for example an LED, and/or sound component, for example playing an alarm, etc. The illumination may be turned on as part of an alert and/or for other purposes.

Optionally the connectable personal accessory may be an Internet of Things (IoT) device.

Optionally the connectable personal accessory and/or the Sensor module may comprise a power source, for example a battery.

Optionally the connectable personal accessory and/or the Sensor module may comprise computing devices.

Optionally the connectable personal accessory may comprise a communications interface, for example as described below.

Optionally the connectable personal accessory may transmit and/or receive data from another connectable personal accessory on the same user and/or another connectable personal accessory on a different user.

Optionally, a single user may adorn one or more connectable personal accessories. Optionally the connectable personal accessory may communicate and share data with additional connectable personal accessories on the same user and/or on other users.

Optionally the connectable personal accessory may detect a distress situation by active and/or passive modes.

Optionally the active mode may be initiated by manual input, such as the user pressing a switch, button, touchscreen, and the like, for example on the connectable personal accessory, a smartphone, or a sensor.

Optionally passive mode may be initiated by a predefined movement, motion, or sequence of motions, for example a hand or head movement that is detected by the Sensor Module and is calculated to be an indication of a distress situation.

Optionally the passive mode may be initiated by detecting data from the user's body, for example brain waves or other physiological state and/or behavioral artifacts that may be calculated to be an indication of a distress situation.

Optionally, a distress situation may be detected in active and/or passive modes, for example by voice analysis, change in distance between two connectable personal accessories, loss of communication between two components of the PSS and/or connectable personal accessory, body movements and/or signaling (for example falling), change in behavior, change in the manner of movements, eyelid movements, and the like.

Form Factor: Jewelry, Clothing and/or Accessories

Optionally the connectable personal accessory may have the form factor of textiles and/or clothing, for example scarves, shirts, garments, pants, dresses, and/or any other type of clothing.

Optionally the connectable personal accessory may be manufactured by additive manufacturing techniques e.g. 3D printing, and/or traditional, new, or other production methods.

Optionally, the connectable personal accessory may take the form factor of one or more types of jewelry and/or a personal accessory, for example: keychains; glasses; necklace for glasses; shoes; shoe accessories (heels, soles, laces, etc.); straps of bags; side kit products (buttons, runners, etc.); belt buckles; cufflinks; head accessories (crown/tiara, bow, hat, hair band, etc.); and sports accessories (headband, sweat-absorbing bracelets, etc.).

Optionally the connectable personal accessory may have the form factor of accessories that can be added to other objects, for example accessories for jewelry (e.g. charm for a charm bracelet), watches, bags, and the like.

Optionally the connectable personal accessory may have the form factor of one or more types of jewelry and/or accessories, for example: bracelets; anklets; arm bracelets; chains and/or necklaces; rings for fingers; rings for toes; earrings; pendants; crowns/tiaras; brooches; watches and/or watch strap or band and the like.

Sensor Module

In some embodiments the Sensor Module comprises a plurality of sensors which may be located on one or more physical devices. In a preferred embodiment, a majority or all of the sensors are mounted on the connectable personal accessory and a smartphone.

Optionally one or more of the sensors may be located on the connectable personal accessory, the User Interface Module and/or any other module of the PSS.

Optionally the sensors may comprise a communication interface and/or hardware controls, for example on/off switches and/or other hardware controls used with sensors and/or monitors.

In some embodiments the Sensor Module may comprise one or more sensors from a list of sensors comprising: axis accelerometer; gyroscope; accelerometers; Global Position System (GPS); dead reckoning location monitors; magnetometer; altimeter (Barometric Pressure Sensor); ambient temperature sensor; ambient light sensor: UV sensor; capacitive sensor; heart rate monitor (HRM); ECG sensor (Electrocardiogram sensor); PPG (Photoplethysmography); HRV (Heart Rate Variability); RR (Respiratory Rate) blood pressure sensor; pulse oximeter sensor; CGM (Continuous Glucose Monitor); RSP (Respiration); GSR/EDA (Galvanic Skin Response/Electrodermal Activity); EEG (Electroencephalogram); EMG (Electromyogram); EOG (Electrooculography); heart rhythm sensor; pulse monitors; body temperature monitors; blood oxygen saturation monitors; biometric physiological monitors; biometric behavioral monitors: brain wave monitors; microphones; cameras, still and/or video; radar; LIDAR; infrared sensors; heat sensors; humidity sensors; sweat sensor: skin conductivity; motion sensor; proximity sensors; position sensor; touch sensor; flaw sensors; pressure sensors; human sensing sensors; vision and imaging sensors; and/or any other type of sensor and/or monitor that may be attached to a user and detect data from the user and/or the user's proximity. Optionally all of the data may be automatically transferred to and/or stored by the Analyzing Module or alternatively analyzed on site.

In some embodiments, a connectable personal accessory may include a user interface. For example, the connectable personal accessory may include an input interface and/or an output interface. For example, the connectable personal accessory may include a mechanism by which a user may create a distress call, which may include at least one of: a panic button; a capacitance sensor; a fingerprint detector; a detector for breakage, e.g. when a locket is pulled off a chain and/or a chain is broken an SOS signal is sent out; and/or a pressure sensor. Alternatively, when the distance between the wonder jewel and the smartphone of the user goes beyond a predefined threshold. Optionally a user interface may include a sound making apparatus, light and/or a display. For example, if a distress signal is sent by a nearby user, an alarm may be activated. The user interface may be implemented by an app executed on a smartphone or other personal device communicatively connected to the connectable personal accessory. The interface may be used to communicate with other users and provide alert or code words for alerting.

In some embodiments, sensors and/or user interface may depend on the type of jewelry. For example, a locket may include a user input interface, whereas a chain may include a breakage detector. Similarly, an ankle bracelet may include a pulse meter whereas an earring may include a sound output interface. Optionally, a user may be advised as to a collection of sensors and/or appropriate pieces of jewelry to give a reliable protections system. For example, a user who chooses a locket hanging on a chain may be recommended to also choose a piece of jewelry that is worn close to the body to facilitate monitoring of vital signs (such as pulse etc.). Optionally, an algorithm may account for the reliability, sensitivity and/or availability of sensors when making decisions as to whether a situation should be treated as dangerous and/or whether to sound an alert. Optionally, the sensitivity and/or reactions of the system may be customizable according to the user.

According to some embodiments of the present invention, using sensors can be for additional lifestyle wellness purposes that will help the wearer wear it throughout the day. For example, if a piece of jewelry is used to remind (a card/sound/lighting or any other way) a certain person to take medication or do other routine actions, if he feels distress or other need for help/communication with people who can help—he can do so immediately and naturally.

Indices and Data Collected

Optionally the Sensor Module may comprise sensors with the means to detect and transmit data used for monitoring at least one physiological phenomenon from a list comprising: heart rate (HR); galvanic skin response (GSR) or electrodermal activity (EDA); skin temperature (SKT); electroencephalogram (EEG); electrocardiography (ECG); heart rate variation (HRV); respiration rate (RR); electromyography (EMG); electrooculography (EOG); brain wave monitor; and/or any other type of data for monitoring physiological and/or biometric phenomenon.

Optionally, the Sensor Module may further comprise additional sensors, for example video recording, digital still image recording, thermal sensors, thermal imaging sensors, computer vision, electrical resistance sensors, electrical induction sensors, color sensors and/or any other type of sensors. Optionally, various indicators concerning distress may be consensually collected and used.

Time Stamping Data

Optionally the sensors and/or a platform in communication with the sensors may comprise means to time stamp data. Optionally the means to time stamp data may be implemented by the sensor, the Analyzing Module, a network for transmitting the sensor data, a third-party apparatus, and/or a user terminal, thereby enabling correlating the time of data from different sensors.

Sensor Communications

Optionally some or all sensors may comprise mechanisms for translating the physiological parameters into electronic data, for example transducers.

Optionally the sensors may comprise an interface to receive and/or transmit electronic data, for example networking interface, Wi-Fi, Bluetooth, Near Field Communication (NFC), Ethernet, USB, wireless interface, wired interface, cellular interface, and/or any other method of communicating electronic data to a network, server, and/or user terminal.

User Interface Module

Optionally the User Interface Module may comprise at least one computing terminal, such as a personal device (e.g., smartphone). Optionally the user terminal may be connected by a network to the Analyzing Module. Optionally the user terminals may be connected directly to the Analyzing Module by any wired or wireless data connection.

In a preferred embodiment, the User Interface Module may comprise a smartphone running the Safety App (SA) which may receive data from the connectable personal accessory and/or Sensor Module, which and transmits the data to a cloud based Analyzing Module.

Optionally the user terminal may comprise a computing platform with processors, computer memory, input devices, display screens, and/or communication interfaces and the like.

Optionally the user terminals may further comprise a user interface, for example a GUI.

Optionally the user terminal user memory may store instructions (either predefined or user selected) that when executed on a processor may provide a user interface, for example a GUI, to the Analyzing Module enabling the user to input commands and/or receive data.

Optionally the user terminal may function to receive input data from an input device, for example initializing data, personal data relating to a user, initial settings for sensors and/or other devices, instructions for alerts, sensor sensitivity and/or other settings for sensors, and/or any other instructions commonly used in initializing monitoring and/or alerting devices.

Optionally the user terminals may be a computer and/or a mobile computing and communicating device for example a smartphone, a laptop computer, a desktop computer, a tablet, a computing device integrated within an automobile, and/or any other type of mobile computing device. Optionally the terminal may comprise a touch screen, voice commands, a mouse or other input device, a keyboard, and/or any other type of display screen and/or computer human interface. Optionally, the terminal comprises both wired and wireless communication capabilities including a network interface, for example Wi-Fi, Bluetooth, Ethernet, cellular, and/or any other communication technology.

Optionally the Personal Safety System comprises an Analyzing Module as described in herein.

Alerting Module

Optionally, the Alerting Module may provide a means for receiving an instruction from the Analyzing Module to set an alert, and further means for alerting a person, persons, community/or institution that a and/or distress situation has occurred and/or is occurring and/or other emotions and preventive measures and/or monitoring a person's feelings.

In a preferred embodiment the Alerting Module may be integrated with the Analyzing Module and may comprise instructions that when executed on an Analyzing Module processor, perform the actions described below.

Optionally the Alerting Module may comprise a computerized device and/or a set of software instructions that when executed on a processor may send electronic messages. For example, the Alerting Module may be configured for a specific user to notify friends, family, neighbors, community members, police, first aid responders, social services, and/or any other recipient.

Optionally the Alerting Module may comprise communications resources to send alerts via cellular text messages, SMS, pre-recorded voice messages, landline and/or cellular networks, messages via social media applications and/or proprietary applications used for alerting medical personnel. Optionally the Alerting Module may comprise means of transmitting an electronic voice, video, graphic, and/or text message, both in real time and/or pre-recorded. Optionally the Alerting Module may comprise means for alerting persons in the vicinity of the user, for example a buzzer, flashing lights, messages displayed on a user terminal, computer monitor, smartphone, and/or other computer devices, messages displayed on any other device comprising a display screen. LCD, LED screen, touch screen, and/or any other type of text display screen and/or device, siren, recorded voice messages, vibration, and or any other type of audible and/or visual notification.

Optionally the Alerting Module may transmit the alert message over electronic networks, and may comprise an interface to electronic networks as described for the User Interface Module.

Sensor Module. and/or the Analyzing Module.

Initializing the Analyzing Module

In some embodiments, the initial settings and/or parameters for the Analyzing Module may be input via the User Interface Module.

Optionally the initial settings may be input by a user of the PSS, another user, a system administrator, and/or any other person or machine.

Optionally the initial settings and/or parameters may comprise a training set of data, physiological parameters related to a single user, user personal information, alert settings, and/or any other settings or parameters related to calculating a distress situation, wellness, and/or for any other situation and use.

Optionally, the user personal parameters may comprise gender, age, weight, medical history, allergies, medications, and the like.

Optionally the initialization may comprise data not specific to a user, for example databases with information on users with similar parameters, a training set of data from other users, data from other connectable personal accessories, and/or any other source.

Calculating a Distress Situation and/or Other Situations

Optionally, data generated by the Sensor Module may be transmitted to the Analyzing Module. Optionally, the Analyzing Module comprises computer instructions that when executed on a processor may receive physiological and other data related to a specific user and may execute an algorithm to calculate a distress situation and/or other situations.

The data may originate from at least one sensor of the Sensor Module, an application on a smartphone for example the Safety App (SA), data from other smartphones in the vicinity of the user, data from members of a community of PSS users, the distance between the connectable personal accessory and the device running the SA, ending, exiting, and/or otherwise stopping the SA, a database comprising historical data for the user, a database comprising historical data for other users, data input via the User Interface module, an intranet, the internet, and/or any other source of data.

Optionally the computer instructions may comprise at least one algorithm, for example algorithms to calculate a distress situation and/or an alert.

Optionally, the Analyzing Module may receive information from an active manual action of the user. For example, the information may be predefined and/or the interface may include —pressing a button, activating the application, voice recognition and/or distress call, and the like.

Optionally, data can be collected from two or more sources and can also work in series so that only a second confirmation will alert the system. This will reduce the possibility of a false alarm.

Algorithms

Optionally the algorithm may comprise at least one mathematical and/or statistical function and/or method chosen from a group comprising artificial intelligence, machine learning, correlation algorithms, clustering algorithms, statistical learning, statistical methods, linear regression, classification, resampling methods, linear model selection and regularization. Polynomial regression, step functions, basis functions, regression splines, smoothing splines, local regression, tree-based methods, support vector machines, unsupervised learning, supervised learning, neural networks, fuzzy logic, Bayesian statistics, methods, and/or classifiers, and/or any other algorithm and/or mathematical function.

Confidence Levels

Optionally the outputs of the algorithm may further comprise a confidence level. Optionally the confidence level of the output may comprise an input for an algorithm calculating a corresponding alert. For example, a calculation of a specific distress situation with a confidence level below a given threshold may result in a calculated alerts being sent to friends and/or family, whereas a confidence level above the threshold may result in different alerts being sent to different and/or additional persons, for example police, authorities and/or social services.

Real-Time Operation

Optionally, the Analysis Module may receive real-time data from the Sensor Module and/or any other source. Real time may correspond to an event to system response on the order of milliseconds or even microseconds. Optionally the real-time data may comprise inputs to the algorithm to verify the calculation, adapt the parameters of the alert, identify false alerts, filter noise, and/or to cancel an alert.

Alerting and Other Actions

Optionally, when a distress situation has been calculated, in addition to activating the Alert Module to transmit alerts, the Analyzing module may initiate other actions, for example turning on and receiving data from additional sensors, for example on a smartphone turning on a camera, microphone. GPS, acceleration sensors, directional sensors, and/or any other sensors, sounding an audible alarm, turning on a light, for example a flashing LED located on any device in the PSS.

Optionally the Analyzing Module may calculate that a situation may develop into a distress situation, and provide an early warning and/or alert to the user and/or other persons. In some embodiments, early warnings may be based on instantaneous sensor readings. For example, based on research it may be known that abusers tend to push their victims into a certain state before attacking them (for example simultaneously stressed and excited). When a user is found to be in such a state, the system may send a warning to the user (e.g. a quiet alarm may be activated from an earring and/or an automatic telephone call may be activated giving an oral warning and/or a warning may be sent to another person who may call the user and/or come to help). Alternatively or additionally, the system may scan a user's history for significant signs (for example, when the user is in a certain place yelling is often detected and/or anger and/or when the person is around another individual and/or the system may warn when certain suspicious individuals are present (suspicious individuals may include people acting in unusual ways and/or people who have past histories of violence and/or people who the user has identified)). Alternatively or additionally, the system may detect slowly developing situations (such as the stress level of a user slowly increasing, especially when in a social location and/or a bar etc.) and/or the system may detect when a user is being taken to an unexpected and/or secluded location especially if the trip is from a bar and/or while the user appears intoxicated and/or unconscious. For example, domestic violence may start with multiple low intensity events. The system may be designed to detect these events and warn a user and/or another person when the pattern appears threatening.

In another example, situations of violence by relatives and spouses (these types of violence often occur over long periods of time and their frequency can vary) may be detected by identifying a recurring pattern and alert the user and/or pre-determined contacts. It is possible that such a situation will allow early detection of domestic violence, aiding the victim and preventing murder. Other risks can be robbery or kidnapping as the wonder jewel appears like any other fashionable accessory.

Optionally, the Analyzing Module may generate periodic reports that summarize a user's level of distress and transmit the reports via the Alerting Module. The report may comprise comparisons with other users sharing a geographic area, personal data characteristics, and/or any other criteria.

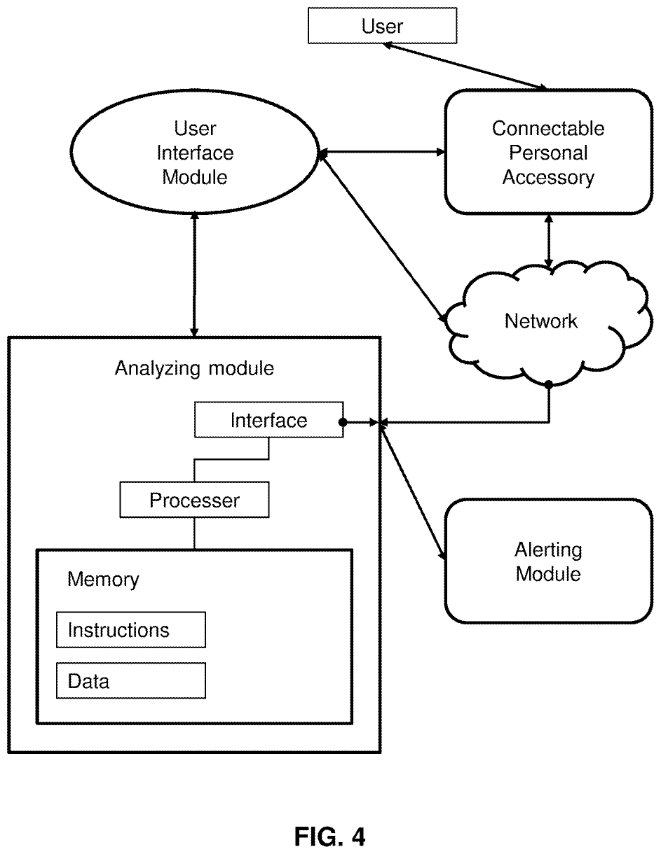

FIG. 4 is a schematic drawing of a Personal Safety System in accordance with an embodiment of the current invention. Optionally some or all of the features illustrated in FIG. 4 may be included in any of the other embodiments illustrated herein.

Network

Optionally the network may be any type of data network, for example the internet, a cloud network, a local area network (LAN), a wide area network (WAN), point-to-point communication, and/or any other type of network. Optionally network may be a wireless network, for example Wi-Fi, Bluetooth, cellular, near-field-communications (NFC) and/or any other network for connectivity between computers. Optionally the network interface enables exchange of information with the network.

Community and/or User Community

Optionally users of a PSS may be organized into user communities, wherein selected users may be given permissions related to other group members to share data, respond to alerts, provide feedback and/or social media accolades, and/or any other action common to user communities.

In some embodiments, the system may be part of a community and/or social network which includes updates, warnings and/or training to encourage user safety and/or proper use of devices.

For example, the community member may be able to choose the operations/actions order and the way in which they wish to take part in the community, in routine everyday life and in times of need (when another member of the community needs help).

Community Members

Community members may include one, two or more audiences for example: connectable personal accessory owners, and individuals from the wider community, etc. In some embodiments, potential community members may undergo security clearances, for example: approval of other community members; registration by a social network/identified email; entering identifying information; checks against criminal databases. Successfully passing the security clearances may result in the user being issued (e.g. in the app) a security credential which allows greater user options and access to other users. For example, a user with a security credential may be considered to be trustworthy and may be permitted to be notified in order to assist with distress situations.

In some embodiments, there may be various community member notification options. For example, an alert may be sent to and/or from a phone and/or an app by voice alert and/or by SMS message. In some embodiments, a connectable personal accessory may include an output interface that sends or receives the alert, for example: voice, lighting, movement.

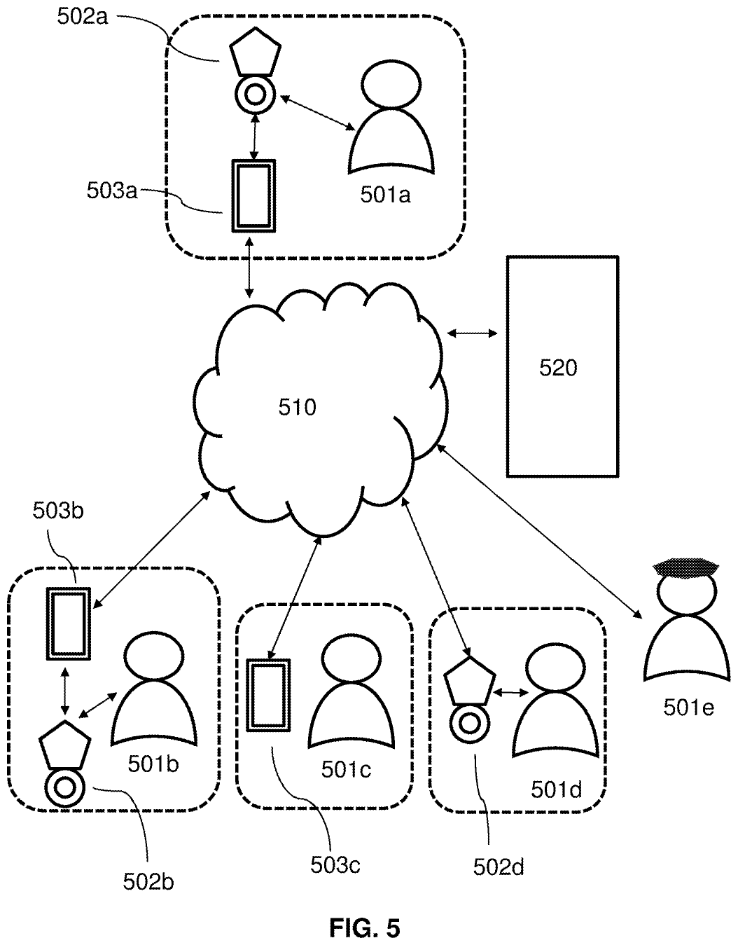

FIG. 5 is a block diagram showing a Personal Safety System 500, according to an embodiment of the invention. Elements of FIG. 5 may be used in any other embodiment described or represented in any other figure herein.

Personal Safety System 500 may include a plurality of connectable personal accessories 502a. 502b. 502d, . . . , etc. Whilst connectable personal accessories 502a. 502b, and 502d have been shown in FIG. 5 as having the form factor of jewelry, particularly as rings, this is only for the purposes of illustration, and it will be apparent that, as described herein, a personal connectable accessory may have many form factors and is not limited solely to jewelry.

Similarly, connectable personal accessories 502a, 502b. 502d may have different form factors. e.g. connectable personal accessory 502a may be an article of jewelry such as a ring, connectable personal accessory 502b may be a garment such as a dress, and connectable personal accessory 502d may be an accessory such as a watch strap.

As shown in FIG. 5, not every user of the Personal Safety System may have a connectable personal accessory, but they may still be part of the user community. For example, users 501a. 501b and 501d may own connectable personal accessories, but in a potential distress situation user 501c and/or authority 501c (e.g. police, authorities, etc.) may be alerted despite not owning connectable personal accessories.

As used in FIG. 5, a dashed box indicates an association between a user and their technologies, for example connectable personal accessory 502a and personal device 503a are each associated with user 501a.

Personal devices 503a, 503b, and 503c may be smartphones, or any other type of personal device (e.g. tablet, personal digital assistant). Personal devices 503a, 503b, and 503c may execute an application/app such as the Safety App described herein.

Thus, according to an embodiment, a system, such as Personal Safety System 500, may include:
(i), at least two connectable personal accessories 502a. 502b, each connectable personal accessory comprising: at least one sensor configured to detect a specified event; and a processor configured to: communicatively connect the connectable personal accessory to at least one data network; and communicate a detection of a specified event over the at least one data network 510;
(ii), a server 520 (e.g. as shown by server 145 in FIG. 2); and
(iii), at least two instances of an application (app) on respective at least two personal devices 503a, 503b communicatively connected, respectively, to the at least two connectable personal accessories, wherein the processor of a first connectable personal accessory 502a is configured to communicate a detection of a specified event to a first instance of the app on a first personal device 503a communicatively connected to the first connectable personal accessory 502a, wherein the first instance app is configured to forward, over the at least one data network 510, the detection of a specified event to the server 520, and wherein the server 520 is configured to: connect to at least one second instance of the app on a second personal device 503b communicatively connected to at least one second connectable personal accessory; and communicate a detection of a specified event to the at least one second instance app.

Alternatively, or complimentarily, server 520 may connect to at least one second instance of the app on a second personal device 503c which is not communicatively connected to a personal accessory and communicate the detection of a specified event to this at least one second instance app.

Alternatively, or complimentarily, server 520 may connect “directly” to at least one second connectable personal accessory e.g. connectable personal accessory 502d and communicate a detection of a specified event to the connectable personal accessory. Connectable personal accessory 502d may have a user interface such as a graphical user interface which may display a notification to user 501d that a detection of a specified event (e.g. a distress situation of user 501a) has been received.

Alternatively, or complimentarily, server 520 may connect to other technologies (not shown) as may be used by authorities 501c, for example communications equipment, a police server, an onboard computer, a radio dispatcher etc.

Data network 510 may be a wireless network such as Wi-Fi. Technologies of the same user association (e.g. connectable personal accessory 502b and personal device 503b each associated with user 501b) may communicate with each other using a data network different to data network 510, for example Bluetooth.

Server 520 may assess whether a received detection is a genuine detection of a specified event. A genuine detection of a specified event may correspond to a detection of a real-world event falling within predefined criteria/ranges, as opposed to a “false alarm” or sensor detections being interpreted incorrectly resulting in an incorrect assessment of the situation. Server 520 may communicate a genuine detection of a specified event to at least one second instance app, for example an instance of the app executed on personal devices 503b and/or 503c.

Server 520 may include a classifier configured to classify the received detection and determine if the received detection is a genuine detection of a specified event.

The classifier may construct a feature vector from the received detection; and determine if the received detection is a genuine detection of a specified event by calculating a similarity distance between the constructed feature vector and at least one pre-constructed feature vector of a pre-configured dataset of feature vectors corresponding to specified events. For example, a pre-configured dataset of feature vectors may exist for different specified events, e.g. intoxication, elevated heart rate, abnormal geographic location. These pre-configured feature vectors may serve as a basis for comparison for the constructed feature vector constructed from the received detection and/or sensor readings. In this way, the classifier may see how similar the detection is to existing specified events, and may be able to determine if the detection corresponds to a similar event.

The classifier may be a pre-trained machine learning model, trained on a training dataset of specified events, and configured to determine if the received detection is a genuine detection of a specified event by comparing to the training dataset of specified events.

A specified event may be one or more of a predefined physiological state; a verbalized key word or phrase; a predefined motion or sequence of motions; and/or a manual input to the at least one sensor.

A predefined physiological state may be, for example, a particular sensor reading or combination of sensor readings. e.g. a heart rate above 130 beats per minute and/or a respiration rate above a particular numeric threshold.

A verbalized key word or phrase may be spoken by a user and/or a potential abuser/attacker, for example “Help”. “I'm going to hit you”, “Hand over your wallet!” etc.

A predefined motion or sequence of motions may be, for example, a head motion or a relative motion between two connectable personal accessories worn by the same user (e.g. moving a ring type connectable personal accessory from one finger to another finger already having another ring type connectable personal accessory). A predefined motion or sequence of motions may be, for example, motions of an abuser/attacker captured by camera/video, e.g. aggressive posturing, build up to a punch, grabbing a user's hair, etc.

A manual input to the at least one sensor may be, for example, pressing a switch or button, breaking a breakable portion of a connectable accessory (e.g. pulling a pendant free from a chain) thereby initiating a flaw capable of being sensed or creating a closed circuit.

Server 520 may be configured to forward, over the at least one data network 510, the detection of a specified event to at least one second instance app (executed, for example on personal device 503b and/or 503c) based on at least one of: (a) a profile of a user of the at least one second instance app (e.g. user 501b. 501c); (b) a preference of at least one of: a user of the first instance app (e.g. user 501a); or a user of the at least one second instance app; (c) a location of a user of the at least one second instance app; (d) an availability of a user of the at least one second instance app; (e) a security credential of a user of the at least one second instance app; and (f) a relationship between a user of the first instance app and a user of the at least one second instance app.

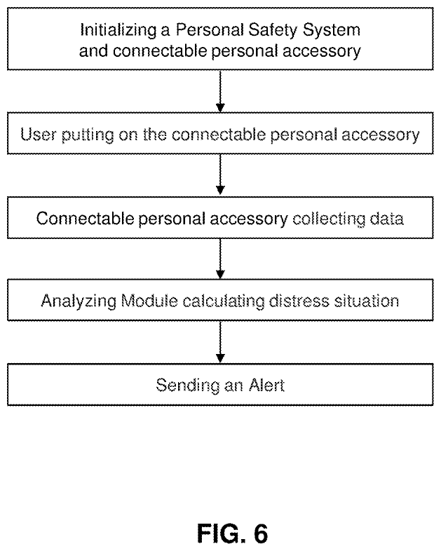

FIG. 6 is a flow chart illustration of a method of using a Personal Safety System in accordance with an embodiment of the current invention.

In some embodiments of the present invention, the steps of the method may comprise initializing a Personal Safety System for a specific user, adorning the connectable personal accessory on a user, the connectable personal accessory collecting data from the user and transmitting the data to an Analyzing Module, the Analyzing module calculating a distress situation, and the Analyzing Module generating alerts.

Optionally, the Analyzing Module is implemented in a server, for example server 520.

Optionally, the Analyzing Module is implemented in an app executed on a personal device, for example the Safety App. Optionally the Analyzing Module comprises a classifier as described above.

Optionally, the step of initializing the PSS comprises initializing the Analyzing Module, Alerting Module, and Sensing Module as described above.

Optionally, the step of initializing may be skipped, for example when factory settings are used.

Optionally, the step of the user putting on the connectable personal accessory comprises putting the connectable personal accessory onto the user's body and/or over clothes, according to the form factor of the connectable personal accessory.

Optionally, the step of the connectable personal accessory collecting data may comprise data from sensors in the Sensor module as described above. The connectable personal accessory may transmit the collected data to the Analyzing Module as described above. For example, the connectable personal accessory may transmit the collected data to the Analyzing Module over at least one data network 510.

Optionally, an additional step may comprise collecting data from other sources, for example from a smartphone running the Safety Application, and/or other sources including artificial intelligence.

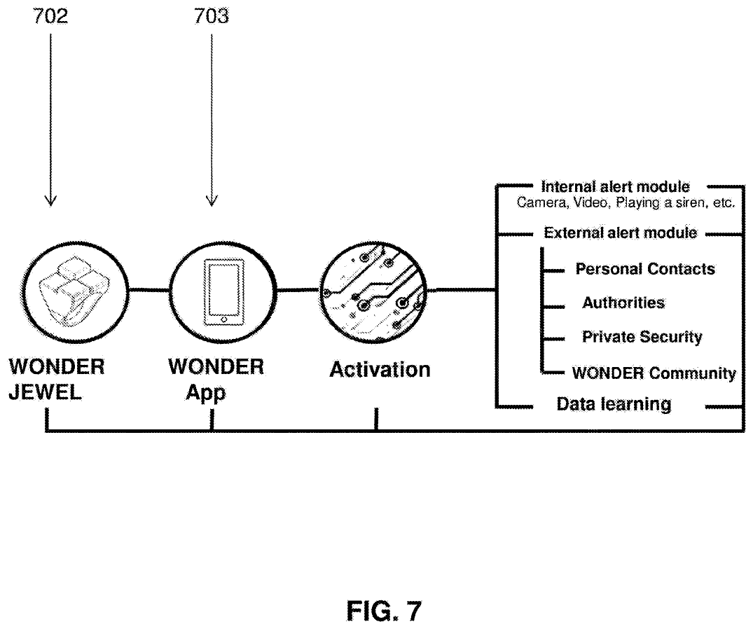

FIG. 7 is a flow chart illustration of a method of a Personal Safety System generating alerts, in accordance with an embodiment of the current invention.

A connectable personal accessory 702 may communicate data to an app 703, such as the Wonder App/Safety App executed on a personal device such as a smartphone.

The app 703 (potentially by communication over a data network with a server) may send an alert. Alternatively, or complimentarily, the app 703 may trigger an immediate response in the personal device (e.g. smartphone). For example, the app 703 may cause the smartphone to begin taking pictures via a camera, begin recording audio and video via a microphone and camera, playing a siren via a speaker, flashing a light etc.

An alert may be sent to members of a user community (e.g. Wonder community), the authorities (e.g. police, fire & rescue, ambulance), and/or personal contacts (accessed, for example, via the personal device).

Members of the user community may receive the alert through their connectable personal accessory/accessories 702 and/or their own instance of app 703. Members of the user community may then be able to respond to the alert and provide assistance. Given the potential for random geographic placement of members of the user community, a member may be able to arrive at the scene of an alert/distress situation sooner than authorities. This may help prevent, assault, and even murder.

According to an embodiment of the present invention there is provided a non-transitory computer readable storage medium containing instructions which, when implemented by at least one processor cause the at least one processor to: communicate a detection of a specified event to a first instance of an app on a first personal device communicatively connected to a first connectable personal accessory; forward, over at least one data network, the detection of a specified event to a server; connect to at least one second instance of the app on a second personal device communicatively connected to at least one second connectable personal accessory; and communicate the detection of a specified event to the at least one second instance app.

According to some embodiments of the present invention, closing an event by the event opener itself or closing an event from at least two sources (from the jewel and the app, the jewel and a community member who came to help), Alternatively Termination and closure of assistance in the event may be done by the person who came to assist (community member, authority, community security organization, private security organization, etc.).

According to some embodiments of the present invention, documentation may be carried out according to the user's choice—type of documentation (microphone, cell phone photography, video photography) and saving and sending the files according to the users' choice—sending in real time to external parties (private security centers, authorities, community, contacts, etc.) It is expected that during the life of a patent maturing from this application many relevant technologies will be developed and the scope of the terms tube and/or connector and/or plastic is intended to include all such new technologies a priori.

In sum, although various example embodiments have been described in considerable detail, variations, and modifications thereof and other embodiments are possible. Therefore, the spirit and scope of the appended claims is not limited to the description of the embodiments contained herein.

Although the invention has been described in conjunction with specific embodiments thereof, it is evident that many alternatives, modifications, and variations will be apparent to those skilled in the art. Accordingly, it is intended to embrace all such alternatives, modifications and variations that fall within the spirit and broad scope of the appended claims.

As used herein the term “about” refers to ±5% The terms “comprises”, “comprising”, “includes”, “including”, “having” and their conjugates mean “including but not limited to”. The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof and/or the term “at least two connectable” may include one compound.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements. All publications, patents and patent applications mentioned in this specification are herein incorporated in their entirety by reference into the specification, to the same extent as if each individual publication, patent, or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

1. A system comprising:
at least two connectable personal accessories, each connectable personal accessory comprising:
at least one sensor configured to detect a specified event; and
a processor configured to:
communicatively connect the connectable personal accessory to at least one data network; and
communicate a detection of a specified event over the at least one data network;
a server; and
at least two instances of an application (app) on respective at least two personal devices communicatively connected, respectively, to the at least two connectable personal accessories,
wherein the processor of a first connectable personal accessory is configured to communicate the detection of a specified event to a first instance of the app on a first personal device communicatively connected to the first connectable personal accessory,
wherein the first instance app is configured to forward, over the at least one data network, the detection of a specified event to the server, and
wherein the server is configured to: connect to at least one second instance of the app on a second personal device communicatively connected to at least one second connectable personal accessory; and communicate a detection of a specified event to the at least one second instance app.

2. The system of claim 1, wherein the server is configured to:
assess whether a received detection is a genuine detection of an event; and
communicate a genuine detection of a specified event to the at least one second instance app.

3. The system of claim 2, further comprising a classifier configured to classify the received detection and determine if the received detection is a genuine detection of a specified event.

4. The system of claim 3, wherein the classifier is configured to:
construct a feature vector from the received detection; and
determine if the received detection is a genuine detection of a specified event by calculating a similarity distance between the constructed feature vector and at least one pre-constructed feature vector of a pre-configured dataset of feature vectors corresponding to specified events.

5. The system of claim 3 wherein the classifier is a pre-trained machine learning model, trained on a training dataset of specified events, and configured to determine if the received detection is a genuine detection of a specified event by comparing to the training dataset of specified events.

6. The system of claim 1, wherein the specified event comprises at least one of:
(a) a predefined physiological state;
(b) a verbalized key word or phrase;
(c) a predefined motion or sequence of motions;
(d) a manual input to the at least one sensor
(e) an unusual event.

7. The system of claim 1, wherein the server is configured to forward, over the at least one data network, the detection of a specified event to the at least one second instance app based on at least one of:
(a) a profile of a user of the at least one second instance app;
(b) a preference of at least one of: a user of the first instance app; or a user of the at least one second instance app;
(c) a location of a user of the at least one second instance app;
(d) an availability of a user of the at least one second instance app;
(e) a security credential of a user of the at least one second instance app; and
(f) a relationship between a user of the first instance app and a user of the at least one second instance app.

8. A non-transitory computer readable storage medium containing instructions which, when implemented by at least one processor cause the at least one processor to:
communicate a detection of a specified event to a first instance of an app on a first personal device communicatively connected to a first connectable personal accessory;
forward, over at least one data network, the detection of a specified event to a server;
connect to at least one second instance of the app on a second personal device communicatively connected to at least one second connectable personal accessory; and
communicate the detection of a specified event to the at least one second instance app.

9. The non-transitory computer readable storage medium of claim 8, further containing instructions which, when implemented by the at least one processor cause the at least one processor to:
assess whether a received detection is a genuine detection of a specified event; and
communicate a genuine detection of a specified event to the at least one second instance app.

10. The non-transitory computer readable storage medium of claim 9, further containing instructions which, when implemented by the at least one processor cause the at least one processor to classify the received detection and determine if the received detection is a genuine detection of a specified event.

11. The non-transitory computer readable storage medium of claim 10, further containing instructions which, when implemented by the at least one processor cause the at least one processor to:
construct a feature vector from the received detection; and
determine if the received detection is a genuine detection of a specified event by calculating a similarity distance between the constructed feature vector and at least one pre-constructed feature vector of a pre-configured dataset of feature vectors corresponding to specified events.

12. The non-transitory computer readable storage medium of claim 10, further containing instructions which, when implemented by the at least one processor cause the at least one processor to determine if the received detection is a genuine detection of a specified event by comparing to a training dataset of specified events.

13. The non-transitory computer readable storage medium of claim 8, wherein the specified event comprises at least one of: a predefined physiological state; a verbalized key word or phrase; a predefined motion or sequence of motions; a manual input to the at least one sensor.

14. The non-transitory computer readable storage medium of claim 8, further containing instructions which, when implemented by the at least one processor cause the at least one processor to: forward, over the at least one data network, the detection of a specified event to the at least one second instance app based on at least one of:
(a) a profile of a user of the at least one second instance app;
(b) a preference of at least one of: a user of the first instance app; or a user of the at least one second instance app;
(c) a location of a user of the at least one second instance app;
(d) an availability of a user of the at least one second instance app;
(e) a security credential of a user of the at least one second instance app; and
(f) a relationship between a user of the first instance app and a user of the at least one second instance app.
